(19) United States
(12) Patent Application Publication
(10) Pub. No.: US 2014/0012656 A1
(43) Pub. Date: Jan. 9, 2014

(54) Digital Self Service Coupon, Discount Deal And Weekly Ad Application Software Platform

(71) Applicant: Mohammed F. Hussain, Troy, MI (US)

(72) Inventor: Mohammed F. Hussain, Troy, MI (US)

(21) Appl. No.: 13/544,626

(22) Filed: Jul. 9, 2012

(51) Int. Cl. G06Q 30/02

(52) U.S. Cl. 705/14.39

(57) ABSTRACT

“Self-Service Digital Coupon, Discount Deal and Weekly Ad Publishing and Management Method” is a method or process that in practice is to be used as a software design logic or algorithm, to develop a custom publishing computer software, integrated with a web server and database server for an end to end solution. All solution components for the applied method use an industry standard web server, database server and web development technologies. A user accesses the custom publishing software via a standard web browser, through the web site, to create or manage their digital coupon, discount deal or weekly ad as a self-service solution. This creation and management method uses a pre-built template gallery, eliminating the need for any third party tools, software or human interaction. The integrated web server, database server and custom publishing software process the user requests and instantly publish them to the web site for immediate availability to any internet users.

### TECHNICAL FIELD OF THE INVENTION

The invention pertains to the unique method or process of the digital coupon, weekly ad and discount deal creation and management in the field of digital advertising and publishing. The invention provides a unique self-service or self-provisioning method for creating and managing digital coupons, weekly ads and discount deals and publishing them to a web site for immediate delivery to the internet audience. The method or process can be applied to a software design or algorithm, to implement a fully automated and self-service software platform to create, manage and publish digital coupons, weekly ads and discount deals on a web site.

### BACKGROUND OF THE INVENTION

In today's digital advertising world, there is a wide variety of digital coupon, discount deal or weekly ad creation methods or processes available, using a variety of software applications or platforms. However, none of them provides a self-service creation and management method or process capability. Also, they are not fully automated for instantaneous creation, management and publishing to a web site. All the existing solutions require manual steps as part of the process. Here is the typical method or process for the creation and management of digital coupon, discount deal and weekly ad solutions that currently exist.

Existing creation method or process:
1. Signup for the digital coupon, discount deal or weekly ads;
2. A digital coupon, discount deal or weekly ad image is manually created using publishing software;
3. The digital coupon, discount deal or weekly ad is submitted via email, ftp or web site upload;
4. A system operator validates the submitted file for proper formatting to conform to the system standard;
5. A system operator publishes the file to the digital coupon, discount deal or weekly ad web site using the publishing tool.

Existing management method or process:
1. An existing digital coupon, discount deal or weekly ad image is manually edited or revised using publishing software;
2. The edited version of the digital coupon, discount deal or weekly ad is submitted via email, ftp or web site upload;
3. A system operator validates the submitted file for proper formatting to conform to the system standard;
4. A system operator removes and publishes the new file to the digital coupon, discount deal or weekly ad web site using the publishing tool.

As described above, the method or process for existing solutions doesn't provide the automated or self-service functionality and requires multiple manual steps to create and manage digital coupons, discount deals and/or weekly ads and publish them to a web site. Also, the existing method or process requires multiple manual steps and users. Applying the existing method or process requires integration and conformance to multiple software applications, platforms and standards.

### SUMMARY OF THE INVENTION

The proposed invention is an end to end method or process for creating and managing digital coupons, discount deals or weekly ads based on a self-service model by using standard web client and server technologies. The software application or platform built using the method or process as a design logic will provide end to end self-service creation, management and publishing capability to a digital advertising web site.

The digital coupon, discount deal or weekly ad web server hosting the creation, management and web site consist of the following:
1. Setup a web server using any standard web hosting software that hosts the web site;
2. Setup a database server for the web server;
3. Setup a database and define the pre-build templates fields on the database server for digital coupons, discount deals and weekly ads, with content fields that will be used for pre-built templates. The templates will be used for creation and update of the content by the user. The database can hold multiple pre-build templates. The number of available pre-built templates is determined by the web server operator. He or she will determine how many digital coupon, discount deal and weekly ad templates to make available to the users. All fields are defined based on what information is needed for each pre-built digital coupon, discount deal and weekly ad template;
4. Create a publishing software application to run on the web server, based on the pre-built template design fields in step 3, using any standard web development language (HTML, Java, PHP etc.);
5. Integrate the publishing software application with the web server and database server so it is accessible to a user when they access the web site via a web browser.

The creation method or process for the self-service digital coupon, discount deal or weekly ad consists of the following:
1. User signup for the digital coupon, discount deal or weekly ad on a web site;
2. User logs in to the web site to access the self-service digital coupon, discount deal or weekly ads software application;
3. User accesses the digital coupon, discount deal or weekly ad publishing software application, via a web browser, through the web site. The web site supplies the front end interface for the publishing software application;
4. User supplies the content of the digital coupon, discount deal or weekly ad based on the pre-defined template gallery fields defined in the software application database via their browser;
5. User supplies any custom graphics (such as company logos) or text (such as company name) for the customization fields defined in the software application database;
6. The self-service software application instantly creates and publishes the digital coupon, discount deal or weekly ad by processing the user defined content data;
7. After creation and publishing, the digital coupon, discount deal or weekly ad is immediately available on the internet.

The management method or process for the self-service digital coupon, discount deal or weekly ad consists of the following:
1. User logs in to the web site using any standard web browser client to access the self-service digital coupon, discount deal or weekly ad software application;
2. User accesses the existing published digital coupon, discount deal or weekly ad software application via web browser client;
3. User updates the content of the digital coupon, discount deal or weekly ad as desired, based on the pre-defined template gallery fields in the software application, via their web browser client;
4. User updates the customization graphics or text for customization fields, if desired;
5. The self-service digital coupon, discount deal or weekly ad software application instantly updates the information and/or image content submitted by the user, and publishes it to the web site;
6. Once the updated content is submitted by the user and published by the web server, the updated digital coupon, discount deal or weekly ad is immediately available on the internet.

The invention significantly reduces digital coupon, discount deal and weekly ad creation and management time by providing self-service and control to the user. A user no longer needs to create the digital coupon, discount deal or weekly ad manually using a separate publishing software. Submission of images via email, ftp or website upload is no longer required. The user does not need to develop a design for their coupon, discount deal or weekly ad, since the pre-built template is supplied by the publishing software application. Significant time is saved in the process, since there is no longer a need for the exchange, validation and approval of digital coupon, discount deal or weekly ad image proofs, required as part of the existing method or process. Eliminating the human exchange of digital coupon, discount deal and weekly ad proofs also provides significant cost savings, as well as eliminating problems arising from human error. All of these benefits also significantly reduce the cost of digital coupon, discount deal and weekly ad creation and management.

The invention method immediately shows the image proof to the user upon publishing. If any change or update is required to the digital coupon, discount deal or weekly ad image, the user can simply follow the above process again, submitting updated content via their web browser. The web server will process and publish the updates immediately.

The invention enables any user to create and manage their digital coupons, discount deals and weekly ads completely.

Below is the end to end method or process summary for the entire digital coupon, discount deal or weekly ad creation and management solution for both claims:
1. A web server is established to host the web site and digital coupon, discount deal and weekly ad publishing software application;
2. A back end database server is established and integrated with the web server and the digital coupon, discount deal and weekly ad publishing application;
3. Pre-built digital coupon, discount deal and weekly ad templates and fields are defined in the database for standard template content as well as customized content. The user will input content to these fields to generate the digital coupon, discount deal or weekly ad image instantly;
4. User signs up via their web browser by accessing the web site to establish secure access;
5. User logs in to the web site to access the individual account they signed up for;
6. User creates or updates the digital coupon, discount deal or weekly ad information and/or image by entering content for the standard and customized fields, then submits it via web browser.
7. The web server, publishing software application and database server process the user content submission and publish it to the web site;
8. After the digital coupon, discount deal or weekly ad is published to the web site, it is immediately available on the internet, via the web site, as a digital advertisement image.

The web server referenced is a standard web server, using any standard web server software. The database server referenced is established using a Microsoft SQL, MySQL or Oracle server. The publishing software application referenced is a custom software, written in standard web development language and based on the supplied method or process.

### BRIEF DESCRIPTION OF THE DRAWINGS:

FIG. 1—A diagram titled “Digital Coupon, Discount Deal and Weekly Ad Solution Architecture” shows the high level internal processing flow of the web server, publishing software and database server integration. An integrated web server, publishing software application and database need to be established for the user requested processing. It also shows the publishing software design logic based in accordance with the invention's method or process, and how the publishing software application processes the user requests.

FIG. 2—A diagram titled “Digital Coupon, Discount Deal or Weekly Ad Creation Method” shows the end to end digital coupon, discount deal or weekly ad creation user request processing to demonstrate the self-service capability according to invention claim.

FIG. 3—A diagram titled “Digital Coupon, Discount Deal or Weekly Ad Management Method” shows the end to end digital coupon, discount deal or weekly ads creation user request processing, to demonstrate the self-service capability according to invention claim.

FIG. 4—A diagram titled “Digital Coupon pre-build Template Layout” shows what is configured within the publishing software application on the web server for the digital coupon pre-build gallery.

FIG. 5—A diagram titled “Digital Deal pre-built Template Layout” shows what is configured within the publishing software application on the web server for the digital discount deal pre-built template gallery.

FIG. 6—A diagram titled “Digital Weekly Ad pre-built Template Layout” shows what is configured within the publishing software application on the web server for the digital weekly ad template gallery.

### DETAILED DESCRIPTION OF PREFERRED EMBODIMENTS:

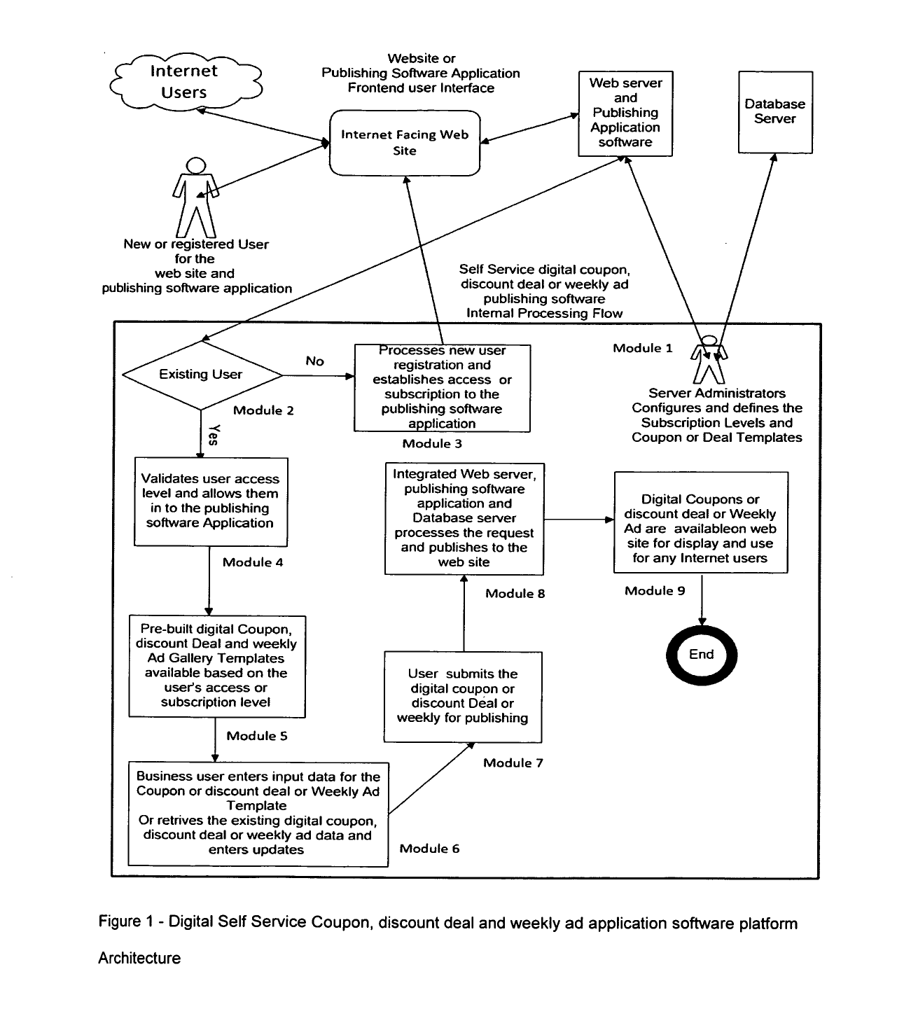

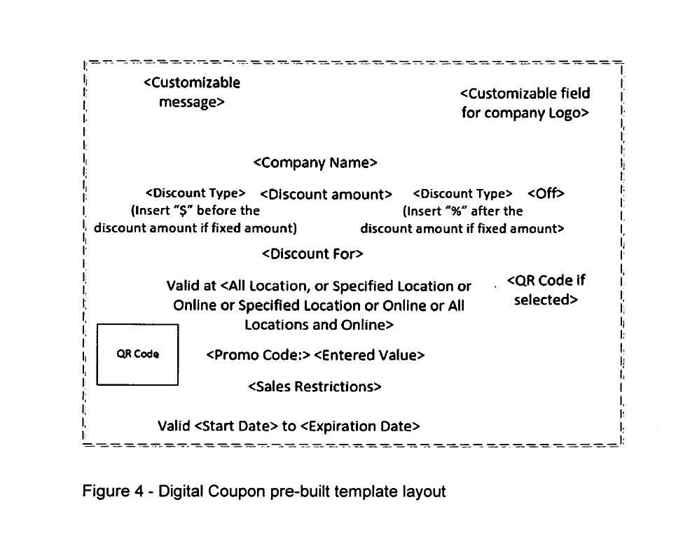

FIG. 1—A diagram titled “Digital Coupon, Discount Deal and Weekly Ad Solution Design” shows the end to end integrated system design implementation components for the application of the method or process. It is a real world computer system architecture implementation of the invention method or process. As shown in the diagram, system components consist of a web server, the publishing software application and a database. All components can be built using standard web technologies. The web server is built using any standard web server software technology (i.e. Microsoft IIS, Apache.) The publishing software application is custom software that needs to be developed as a computer code or program using any standard web development language (HTML, Java, .Net or PHP.) The database server is built using any standard database software technology (i.e. Microsoft SQL, Oracle, or MySQL.) The web server and software publication processing runs on the web server. The database runs on the database server. The publishing software is the central part of the application, where the invented method and process is used as software design logic. It needs to be custom developed and is not available in the existing market. However, it is developed using the standard web development technologies available on the market. The publishing software application uses the database server to define the pre-built digital coupon, discount deal and weekly ads templates. The fields are both standard and user customizable. Standard fields are where the user enters their information in a pre-defined format. Customizable fields are where the user enters their unique information. In this case, the user is generating digital coupons, discount deals or weekly ads for a company. The field description and definition will be detailed later as a part of FIG. 4 through FIG. 6. To develop the custom publishing software, using the invention method or process as the software design logic or algorithm, the software must be developed in modular form. As shown in FIG. 1, there are 9 modules. Each module performs either a partial or full step of the invention claim for computer system processing, along with the integrated standard web and database server software. Detailed software design logic and applied invention methods are supplied below:

Module 1—as shown in FIG. 1, performs the system configuration and setup. The user access level and pre-defined templates are defined using this module. This module allows the system operator or administrator of the system to configure one or more user access levels and pre-build templates associated with them. So a user with a certain access level will have pre-defined digital coupon, discount deal and weekly ad template galleries available to them when they login. The total number of access levels and associated pre-defined templates must be defined as part of the custom publishing software development. If the total number of access levels and associated pre-built template galleries needs to increase or decrease, the custom publishing software program or code must be updated.

Module 2—as shown in FIG. 1, performs the user validation and checks to see if the user visiting the web site and attempting to login to the system is a new or existing user. If the visitor is a valid existing user of the publishing software application, it will allow them access and route them to Module 4. If the visitor is a new user, it will route them to Module 3 to sign up and establish valid credentials, a User ID and password, for the digital coupon, discount deal and weekly ad publishing software application. If a user already has a valid User ID and password on the system, Module 1 routes them Module 4.

Module 3—as shown in FIG. 1, allows a user to register on the system by supplying the required user specific information set forth by publishing software application. This module processes new user registrations and establishes their access levels and associated pre-built digital coupon, discount deal and weekly ad template access.

Module 4—as shown in FIG. 1, validates the user access level and grants access to the software application and associated pre-built digital coupon, discount deal or weekly ad template repository.

Module 5—as shown in FIG. 1, presents the available digital coupon, discount deal and weekly ad template galleries to the user, based on their access or subscription level.

Module 6—as shown in FIG. 1, allows a user to enter new digital coupon, discount deal or weekly ad content data for both standard and customizable fields of the pre-built templates. If the user is updating an existing digital coupon, discount deal or weekly ad, it also allows them to retrieve existing images and update both standard and customizable field contents. This software module processes the entry of both new digital coupon, discount deal or weekly ad creation or content updates for ones that already exist.

Module 7—as shown in FIG. 1, allows the user to submit content for new digital coupon, discount deal or weekly ad creation. It also handles content update submission for existing digital coupons, discount deals or weekly ads. This module allows submission for both the invention claim methods and processes.

Module 8—as shown in FIG. 1, publishes the digital coupon, discount deal or weekly ad, whether a new creation or content update, by routing the request to the database server and web server. The database server processes the request and updates the database. The web server processes the request and publishes the coupon, discount deal or weekly ad to the web site.

Module 11—as shown in FIG. 1, is where the web server displays the newly created digital coupon, discount deal or weekly ad, or content update of an existing one, to the web site. The newly created digital coupon, discount deal or weekly ad is visible to any internet users when they visit the web site.

FIG. 1—illustrates the end to end method or process for establishing a digital coupon, discount deal and weekly ad publishing system, consisting of a web server, database server and publishing software application. It also illustrates the software design logic and user request processing for the custom publishing software application development, based on the claimed invention method or process. Module 1 software code can be updated to add additional pre-build template galleries to the established publishing system, and updates the existing pre-build template galleries to add additional fields. This is the method used for customizing the existing pre-built templates after the initial setup or adding news ones later. Any updates to the software code or program for Module 1 are presented and processed by Modules 4 through 8.

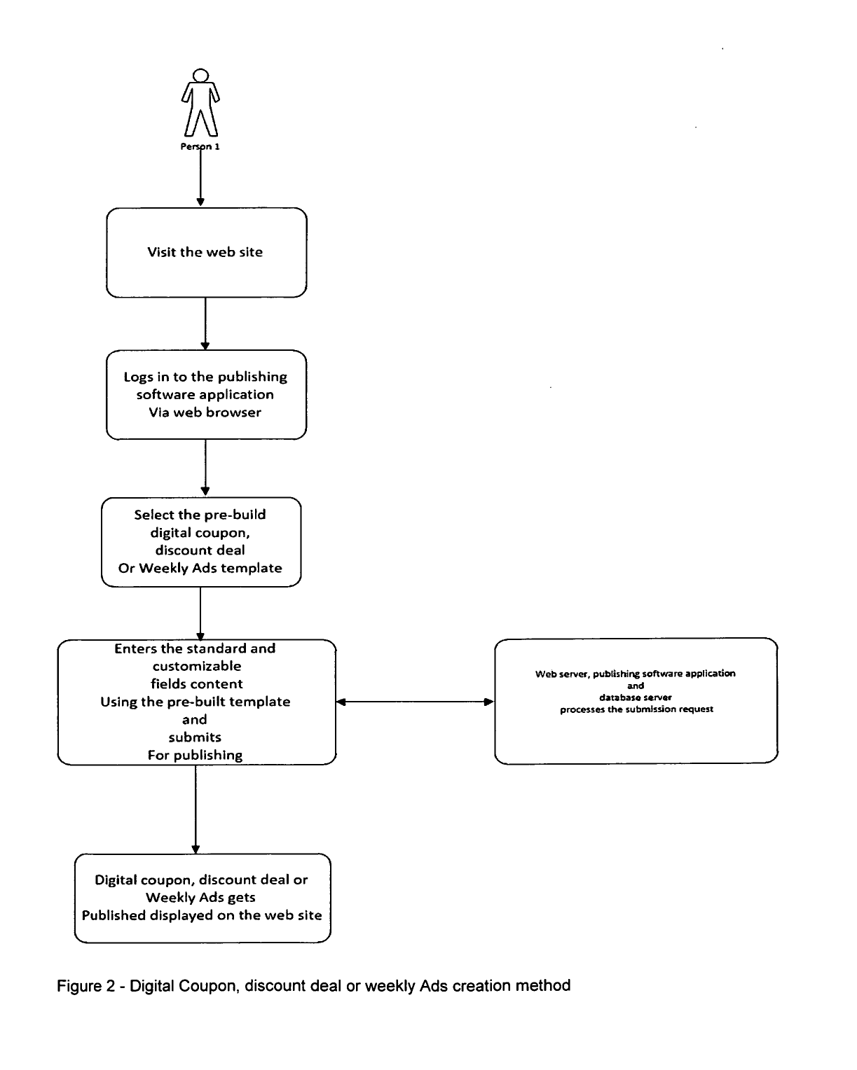

FIG. 2—shows the digital coupon, discount deal or weekly ad creation method or process for the claimed invention method or process after establishing the publishing system shown in FIG. 1. As shown in the diagram, a user visits the web site and logs in to the system via any standard web browser. The user is then presented with the pre-built digital coupon, discount deal and weekly ad gallery templates. The user enters the content for both standard and customizable fields of the pre-built templates, and submits them for publishing. Upon submission, the integrated web server, publishing software application and database server process the submitted request and immediately display the digital coupon, discount deal or weekly ad on the web site.

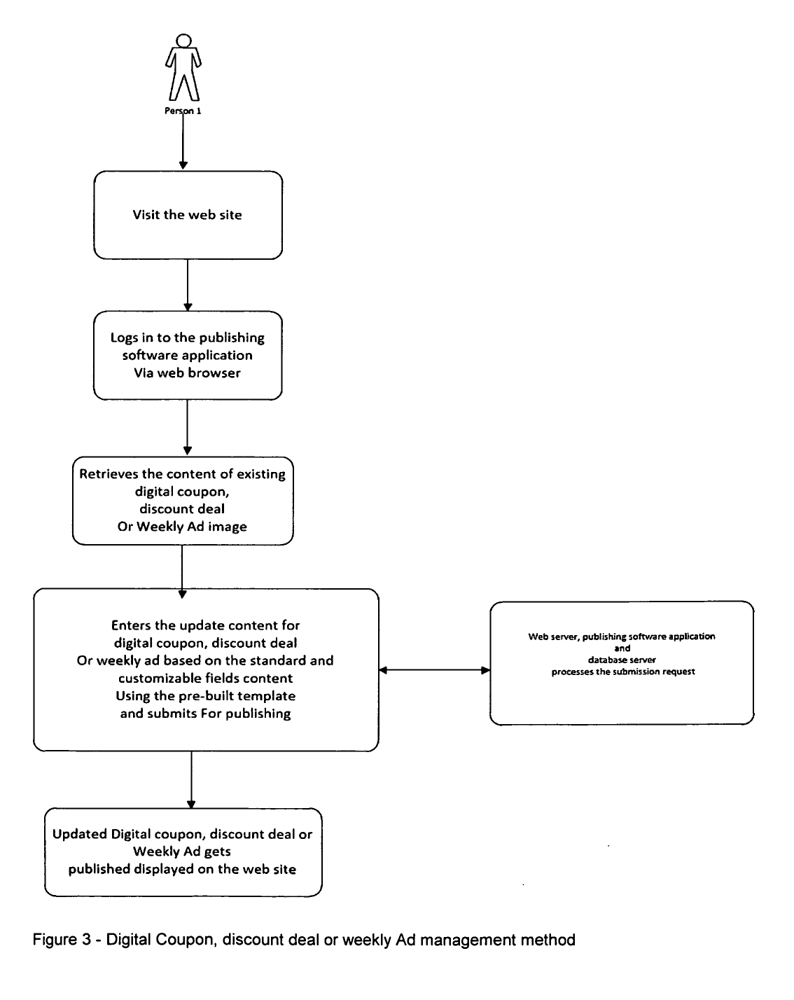

FIG. 3—shows the digital coupon, discount deal or weekly ad management method or process for the claimed invention method or process after establishing the publishing system shown in FIG. 1. As shown in the diagram, a user visits the web site and logs in to the system via any standard web browsers. The user is then retrieves the existing digital coupon, discount deal or weekly ad and enters the content update via the web browser. The user can enter content updates for both standard and customizable fields, based on the pre-built templates, and submit them for publishing. Upon submission, the integrated web server, publishing software application and database server process the submitted request and immediately display the updated digital coupon, discount deal or weekly ad on the web site.

FIG. 4—shows the layout, standard fields and customizable fields of a pre-built digital coupon template that is configured by the publishing software's Module 1 in FIG. 1. This demonstrates the practical application of the claimed method or processes. The total number of fields shown in FIG. 4 can be adjusted to increase or decrease by updating the publishing software code or program, in FIG. 1. Below are the field descriptions for each field.
Company Name: (User types in their company name)
Customizable message text: (User types in any text)
Discount Type: (Drop down list—user selects one of the following options)
   Fixed Amount
   Percentage Based
   Free
Discount For: (Drop down list—user selects one of the following options)
   Total Purchase
   Specific Item
   (If they select “Specific Item,” another field opens with the field name “Item Name,” where they type in the name of the item.)
Item Name: (User types in name of the item if “Specific Item” was selected above.)
Location: (Drop down list—user selects one of the following options)
   All Locations
   Specific Locations
   Online
   All Locations and Online
   Specific Locations and Online
   (If they select “Specific Locations” or “Specific Locations and Online,” another field opens with the field name “Specific Locations,” where they type in the location name(s), i.e. Location A, Location B etc.)
Specific Locations: (User types in if “Specific Locations” was selected above)
Promo Code: (User types in if they want to use a promo code. If they don't type anything, the field stays blank.)
Sales Restrictions: (User types in any offer restrictions they may have)
Start Date: (User selects this from the calendar that appears)
Expiration Date: (User selects this from the calendar that appears)
Logo: (User can upload a company logo. If they don't supply a logo, it stays blank.)
QR Code: (Drop down list—user selects one of the following)
   Yes
   No
   (If they select “Yes,” the QR code is inserted into the designated area of the digital coupon template when they publish it. If they select “No,” the space is left blank.)

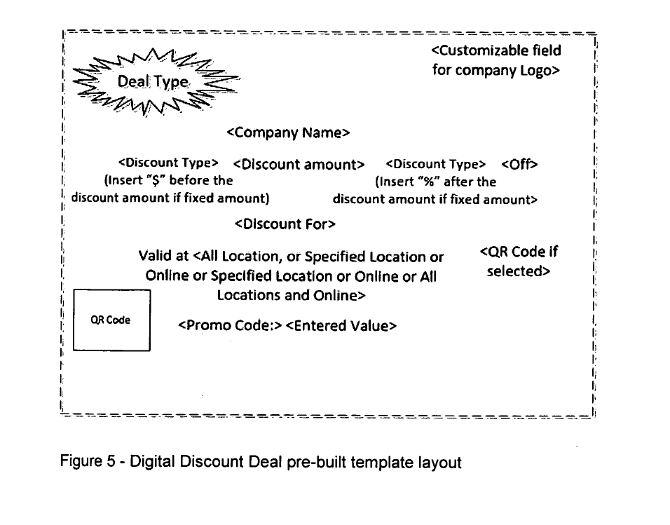

FIG. 5—shows the layout, standard fields and customizable fields of a pre-built digital discount deal template that is configured by the publishing software's Module 1 in FIG. 1. This demonstrates the practical application of the claimed method or processes. The total number of fields shown in FIG. 5 can be adjusted to increase or decrease by updating the publishing software code or program, in FIG. 1. Below are the field descriptions for each field.
Company Name: (User types in their company name.)
Deal Type: (Drop down list—user selects from the following options)
   Daily
   Weekly
   Yearly
Discount Type: (Drop down list—user selects from one of the following options)
   Fixed Amount
   Percentage Based
   Free
Discount For: (Drop down list—user selects from the following options)
   Total Purchase
   Specific Item
   (If they select “Specific Item,” another field opens up with the field name “Item Name,” where they type in the name of the item)
Item Name: (User types in name of the item if “Specific Item” was selected above)
Location: (Drop down list—user selects one of the following options)
   All Locations
   Specific Locations
   Online
   All Locations and Online
   Specific Locations and Online
   (If they select “Specific Locations” or “Specific Locations and Online,” another field opens with the field name “Specific Locations,” where they type in the location name(s), i.e. Location A, Location B etc.)
Specific Locations: (User types in if “Specific Locations” was selected above)
Promo Code: (User types in if they want to use a promo code. If they don't type anything, the field stays blank.)
Sales Restrictions: (User types in any offer restrictions they may have)
Start Date: (User selects this from the calendar that appears)
Expiration Date: (User selects this from the calendar that appears)
Logo: (User can upload a company logo. If they don't supply a logo, it stays blank.)
QR Code: (Drop down list—user selects from the following)
   Yes
   No
   (If they select “Yes,” the QR code is inserted into the designated area of the digital discount deal template when they publish it. If they select “No,” the space is left blank.)

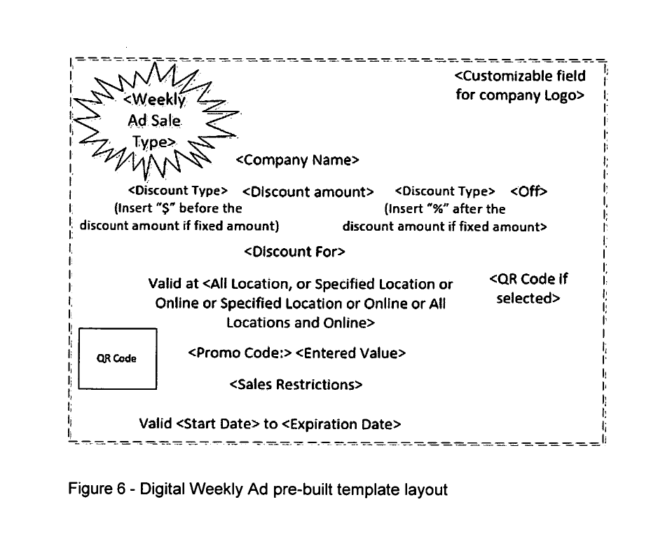

FIG. 6—shows the layout, standard fields and customizable fields of a pre-built digital weekly ad template that is configured by the publishing software's Module 1 in FIG. 1. This demonstrates the practical application of the claimed method or processes. The total number of fields shown in FIG. 6 can be adjusted to increase or decrease by updating the publishing software code or program, in FIG. 1. Below are the field description for each field.
Company Name: (User Types in their company name.)
Weekly Ads Sale Type: (Drop down list—user selects from the following options)
   Sale
   Special
Discount Type: (Drop down list—user selects from one of the following options)
   Fixed Amount
   Percentage Based
   Free
Discount For: (Drop down list—user selects from the following options)
   Total Purchase
   Specific Item
   (If they select “Specific Item,” another field opens up with the field name “Item Name,” where they type in the name of the item)
Item Name: (User types in name of the item if “Specific Item” was selected above)
Location: (Drop down list—user selects from the following options)
   All Locations
   Specific Locations
   Online
   All Locations and Online
   Specific Locations and Online
   (If they select “Specific Locations” or “Specific Locations and Online,” another field opens with the field name “Specific Locations,” where they type in the location name(s), i.e. Location A, Location B etc.)
Specific Locations: (User types in if “Specific Locations” was selected above)
Promo Code: (User types in if they want to use a promo code. If they don't type anything, the field stays blank.)
Sales Restrictions: (User types in any offer restrictions they may have)
Start Date: (User selects this from the calendar that appears)
Expiration Date: (User selects this from the calendar that appears)
Logo: (User can upload a company logo. If they don't supply any logo, it stays blank.)
QR Code: (Drop down list—user selects from the following)
   Yes
   No
   (If they select “Yes,” the QR code is inserted into the designated area of the digital weekly ad template when they publish it. If they select “No,” the space is left blank.)

Conclusion:

The claimed invention method or process for self-service creation and management of digital coupons, discount deals and weekly ads are clearly and distinctly demonstrating practical use in FIG. 1 through FIG. 6.

Demonstrated figures show the practical application and usage of the claimed method or process and how it is unique and not available with any existing system. As mentioned in the background of the invention, existing methods require usage of multiple software applications, software compatibility, and human validation of image proofs through human interaction by multiple parties. The claimed method or process, as applied and built using available standard web technologies, creates an end to end solution with a single user performing the steps and publishing it instantly to a web site for immediate use. Each user has full control of creating and/or managing their digital coupons, discount deals and/or weekly ads. The claimed method or process provides a distinct digital coupon, discount deal and weekly ad publishing platform that eliminates significant time, cost human interaction and room for error. It is a uniquely more efficient model than any that currently exists.

I claim the following:

1. A method or process for self-provisioning creation of a digital coupon, discount deal or weekly ad advertisement for publishing on a web site, comprised of the following:
Establishing a web site on a host computer for a digital coupon, discount deal or weekly ad publishing software application that can be accessed by any web browsers from anywhere on the internet;
Establishing a custom publishing software application for a digital coupon, discount deal or weekly ad that can be accessed by any web browser from anywhere on the Internet via a web site;
Establishing a database server for defining digital coupon, discount deal or weekly ad publishing software application content fields;
Establishing a pre-defined template gallery and user-defined content fields as a part of the digital coupon, discount deal or weekly ad publishing setup;
Each browser client accesses the publishing software application on the server using a standard browser (Internet Explorer, Firefox, Chrome etc.);
Each browser client registers for digital coupon, discount deal or weekly ad publishing using the automated registration system on the web site;
Upon registration, a software application on the host computer or web server creates a unique digital advertisement publishing web page, specific to the browser client, on which to publish digital coupons, discount deals or weekly ads;
The browser client supplies the digital coupon, discount deal or weekly ad content for creation;
The content data fields are maintained in a database table on the backend server;
The digital coupon, discount deal or weekly ad publishing software application creates the advertisement and publishes it on the web site instantly, to the unique digital advertisement publishing page created earlier;
Upon publishing the digital coupon, discount deal or weekly ad, it is immediately available on the internet;
Using the described method or process, a digital coupon, discount deal or weekly ad is created using this fully self-provisioning method.
The claim is a method or process claim, since the described method or process can be used as a software design logic and applied to build a software application that will allow self-provisioning of digital coupons, discount deals and weekly ad advertisement publishing on a web site.
With the proposed method or process, digital coupon, discount deal or weekly ad creation is a fully automated process. It is a completely self-service creation and publishing method or process.

2. A method or process for self-service management of digital coupons, discount deals or weekly ads, for publishing on a web site, comprised of the following:
Establishing a web site on a host computer for a digital coupon, discount deal or weekly ad publishing software application that can be accessed by any web browser client on the internet;
Establishing a custom publishing software application for a digital coupon, discount deal or weekly ad that can be accessed by any web browsers from anywhere on the internet via a website;
Establishing a database server for defining digital coupon, discount deal or weekly ad publishing software application content fields;
Each browser client accesses the publishing software application on the host computer using a standard browser (Internet Explorer, Firefox, Chrome etc.) from anywhere on the internet;
Each browser client retrieves and updates any existing published digital coupon, discount deal or weekly ad content by supplying the updated content;
The content fields for update are maintained in a database table on the backend server;
A Digital coupon, discount deal or weekly ad publishing software application updates content and publishes it to the website instantly, on the unique digital publishing page specific to the browser client;
Upon content update and publishing, the digital coupon, discount deal or weekly ad is immediately available on the internet;
Using the described method or process, digital coupon, discount deal or weekly ad content is updated using a fully self-service management method.
The claim is a method or process claim, since the described method or process can be used as a software design logic and applied to build a software application that will allow self-provisioning of digital coupon, discount deal or weekly ad advertisement publishing on a web site.
With the proposed method or process, digital coupon, discount deal or weekly ad content updating and management is fully automated. It is a completely self-service content updating and management publishing method or process.
